(19) United States
(12) Patent Application Publication
(10) Pub. No.: US 2021/0129279 A1
(43) Pub. Date: May 6, 2021

(54) WORKPIECE TRANSFERRING TOOL

(71) Applicant: FANUC CORPORATION, Yamanashi (JP)

(72) Inventor: Masahiro MORIOKA, Yamanashi (JP)

(73) Assignee: FANUC CORPORATION, Yamanashi (JP)

(21) Appl. No.: 17/062,919

(22) Filed: Oct. 5, 2020

(30) Foreign Application Priority Data
Nov. 1, 2019 (JP) 2019-199983

(51) Int. Cl. B23Q 7/04

(52) U.S. Cl. CPC B23Q 7/046; B25J 9/108; B23Q 7/043

(57) ABSTRACT

A workpiece transferring tool including a base mounted on a distal end of a wrist of a robot, a workpiece holder releasably holding a workpiece, and a movable connection unit connecting the workpiece holder to the base so that the workpiece holder is displaceable in an escape direction of an external force acting on the workpiece. This can prevent an excessively large external force from acting on the robot due to the workpiece and can prevent frequent accidental stop of the robot.

### CROSS-REFERENCE TO RELATED APPLICATIONS

This application is based on and claims priority to Japanese Patent Application No. 2019-199983 filed on Nov. 1, 2019, the content of which is incorporated herein by reference in its entirety.

### FIELD

The present disclosure relates to a workpiece transferring tool.

### BACKGROUND

As a tool fixed to a distal end of a wrist of a robot to transfer a workpiece, known tools includes a gripping type tool gripping a workpiece between two or more openable and closable claws, a suction type tool attracting the workpiece or the like (e.g., see Japanese Unexamined Patent Application, Publication No. 2018-111174).

### SUMMARY

An aspect of the present disclosure provides a workpiece transferring tool including a base mounted on a distal end of a wrist of a robot, a workpiece holder releasably holding a workpiece, and a movable connection unit connecting the workpiece holder to the base so that the workpiece holder is displaceable in an escape direction of an external force acting on the workpiece.

### BRIEF DESCRIPTION OF DRAWINGS

FIG. 1 is a front view showing a workpiece transferring tool according to an embodiment of the present disclosure.

FIG. 2 is a perspective view showing a state where the workpiece transferring tool of FIG. 1 is mounted to a robot.

FIG. 3 is a front view illustrating an operation of the workpiece transferring tool of FIG. 1.

FIG. 4 is a perspective view showing a first modification of the workpiece transferring tool of FIG. 1.

FIG. 5 is a front view illustrating the operation of the workpiece transferring tool of FIG. 4.

FIG. 6 is a front view showing a second modification of the workpiece transferring tool of FIG. 1.

FIG. 7 is a front view showing a third modification of the workpiece transferring tool of FIG. 1.

FIG. 8 is a front view showing a fourth modification of the workpiece transferring tool of FIG. 1.

### DETAILED DESCRIPTION OF EMBODIMENTS

Hereinafter, description will be made as to a workpiece transferring tool 1 according to an embodiment of the present disclosure with reference to the drawings.

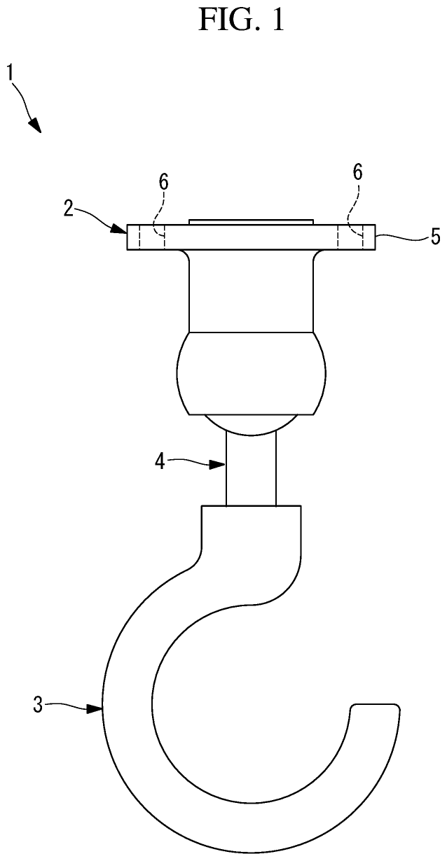

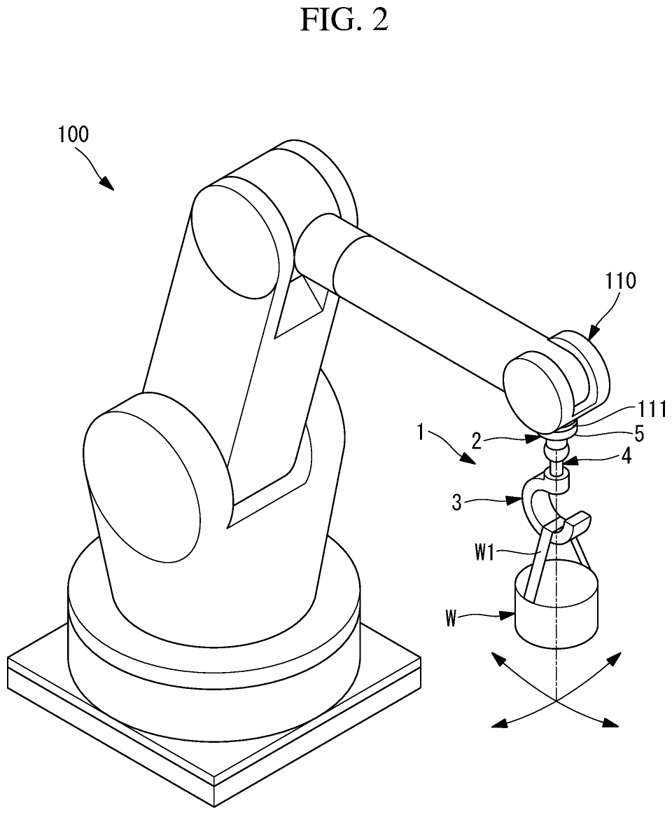

As shown in FIG. 1 and FIG. 2, the workpiece transferring tool 1 according to the present embodiment includes a base 2 fixed to a distal end of a wrist 110 of a robot 100, a workpiece holder 3 holding a workpiece W, and a movable connection unit 4 connecting the workpiece holder 3 to the base 2 in a movable manner.

The base 2 includes a flange part 5 that comes in contact closely with an attachment flange 111 provided at the distal end of the wrist 110. In the flange part 5 of the base 2, a plurality of attachment holes are provided through which bolts 7 to be fastened to screw holes 6 of the attachment flange 111 extend.

In an example shown in the drawing, the workpiece holder 3 is a hook on which a handle W1 provided in the workpiece W is hooked and hung.

The movable connection unit 4 rotatably connects the hook 3 to the base 2 via a spherical bearing (a rotation support mechanism).

Specifically, as shown in FIG. 2, when respective shafts (arm members) of the robot 100 are arranged with a posture in which the attachment flange 111 at the distal end of the wrist 110 is directed downward, the hook 3 is disposed under the base 2. Then, when an external force in a horizontal direction acts on the workpiece W hung on the hook 3, the hook 3 is swung relative to the base 2 about a center point of the spherical bearing 4. Use of the spherical bearing 4 enables the hook 3 to swing relative to the base 2 in a pushed direction by the external force, which means any external force in horizontal direction.

Hereinafter, an operation of the workpiece transferring tool 1 including the above configuration according to the present embodiment will be described.

To transfer the workpiece W by use of the workpiece transferring tool 1 according to the present embodiment, the handle W1 of the workpiece W is hooked on the hook 3 to hang the workpiece W, in a state where the respective shafts of the robot 100 are arranged with the posture of the attachment flange 111 at the distal end of the wrist 110 being directed downward.

In this state, the robot 100 is operated, so that the workpiece W hung on the hook 3 can be transferred to a different position.

In this case, the greater a weight of the workpiece W, a larger torque may act on each shaft of the robot 100, even if an acceleration of the robot 100 is small.

In particular, the robot 100, such as a cooperative robot, may be equipped with a torque sensor on each shaft and may be provided with a stop safety function to stop the operation in case where the large torque is detected by one of the torque sensors.

However, if the robot 100 is stopped only because the robot 100 accelerates to transfer the workpiece W, an operation efficiency will be greatly reduced.

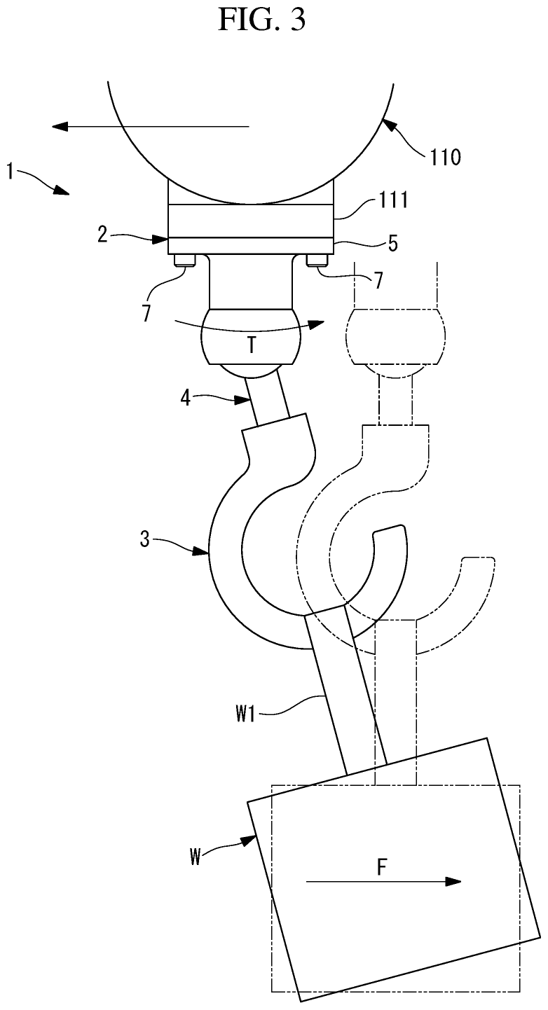

In the workpiece transferring tool 1 according to the present embodiment, in case where the workpiece W hung on the hook 3 is transferred in the horizontal direction as shown in FIG. 3, inertia of the workpiece W generates an external force (an inertia force) F that acts on the workpiece W in a direction opposite to an acceleration direction of the robot 100. In this case, according to the workpiece transferring tool 1 of the present embodiment, a torque T generated by the external force F causes the hook 3 to swing relative to the base 2 about the center point of the spherical bearing 4.

That is, the torque T generated by the inertia of the workpiece W is alleviated by rotation of the hook 3 to the base 2 at a position of the spherical bearing 4, and the torque T detected by the torque sensor of each shaft can be reduced.

This has an advantage that, even if the acceleration of the robot 100 is set to be larger, accidental stop of the robot 100 during a workpiece W transfer operation by the stop safety function can be prevented, unlike a case where the workpiece transferring tool 1 according to the present embodiment is not used.

Furthermore, in case where the workpiece W to be transferred is in contact with peripheral equipment, the external force F that is unexpected may be detected by the torque sensor due to the operation of the robot 100. Also, in this case, the external force F that acts on the workpiece W causes the hook 3 to swing relative to the base 2 at the position of the spherical bearing 4, so that the torque T detected by the torque sensor of each shaft can be reduced.

Thus, the workpiece transferring tool 1 according to the present embodiment has advantages that frequent stop of the robot 100 being operated due to false detection of the external force F in the robot 100 including the torque sensor can be prevented and that decrease in efficiency of the workpiece W transfer operation can be prevented.

In particular, the spherical bearing 4 is employed as the movable connection unit, and hence also in case where the workpiece W is transferred in any horizontal direction, the torque T applied to each shaft can be alleviated.

Furthermore, since the spherical bearing 4 is employed as the movable connection unit, the workpiece W can be disposed at a predetermined positioning position by gravity after the robot 100 is stopped.

To forcibly dispose the hook 3 at the predetermined positioning position to the base 2, an urging means (not shown) made of an elastic body such as a spring may be provided. This allows the workpiece W to be stopped at the predetermined positioning position more quickly.

Note that in the present embodiment, as the movable connection unit, the spherical bearing 4 is illustrated. Alternatively, a universal joint (not shown) may be employed. Even the universal joint can alleviate the torque T against the external force F in any horizontal direction.

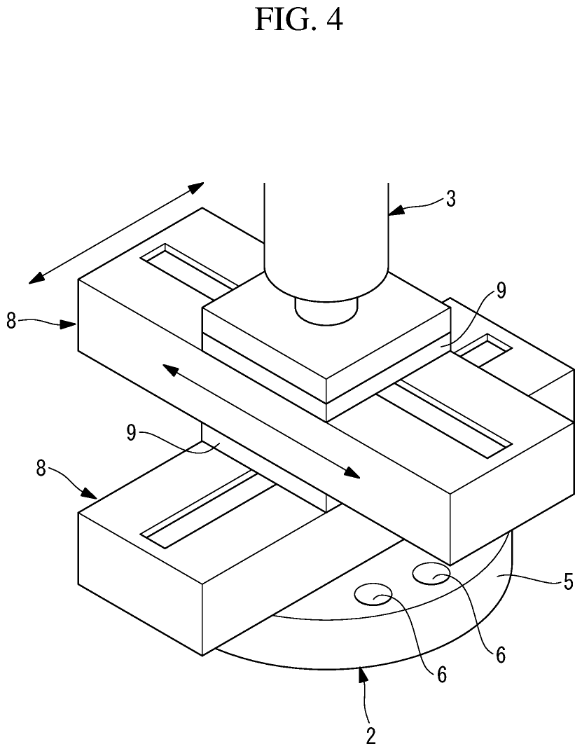

Furthermore, for the movable connection unit, as shown in FIG. 4, a linear movement mechanism 8 may be employed to support the hook 3 to the base 2 in two horizontal directions crossing each other in a linearly movable manner. In the present embodiment, two one-axis linear movement mechanisms 8 are stacked, and sliders 9 is configured to be movable in two orthogonal directions.

One of the linear movement mechanisms 8 is fixed to the flange part 5 of the base 2.

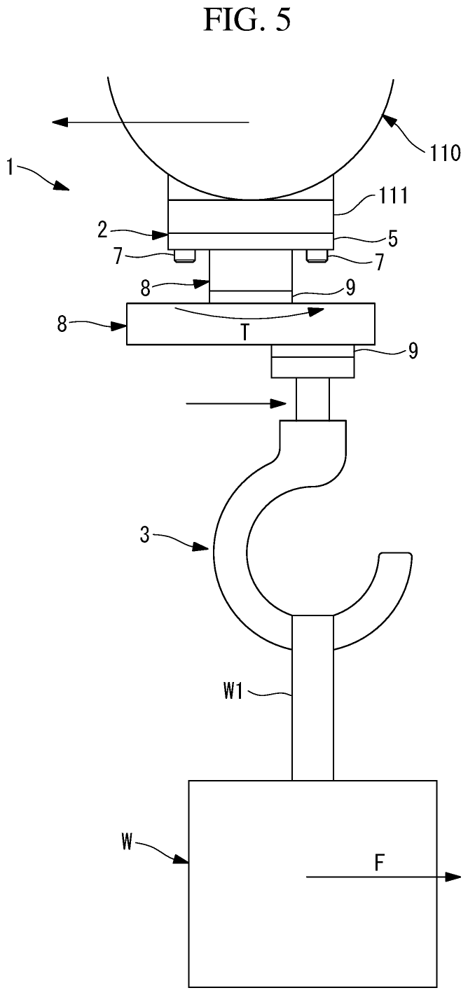

As shown in FIG. 5, the hook 3 is fixed to the slider 9, and the flange part 5 is fixed to the attachment flange 111.

Also, according to this configuration, the external force F generated by the inertia of the workpiece W is reduced by linearly moving and releasing the hook 3 from the base 2 in a direction of the external force F, and the torque T detected by the torque sensor of each shaft can be alleviated. Also, according to the linear movement mechanism 8, the torque T can be alleviated relative to the external force F in any horizontal direction.

In case of employing the linear movement mechanism 8 as the movable connection unit, it is preferable to provide an urging means (not shown) made of an elastic body such as a spring for forcibly disposing the hook 3 at the predetermined positioning position to the base 2. This allows the hook 3 to be stopped close to a center of a movement range of the two linear movement mechanisms 8 in a state where the robot 100 is stopped.

Additionally, as the movable connection unit, the movable connection unit available also for the transfer of the workpiece W in any horizontal direction is illustrated. Alternatively, in case where a moving-direction in the horizontal direction is known in advance, a movable connection unit that can alleviate the external force F only in the moving-direction may be employed.

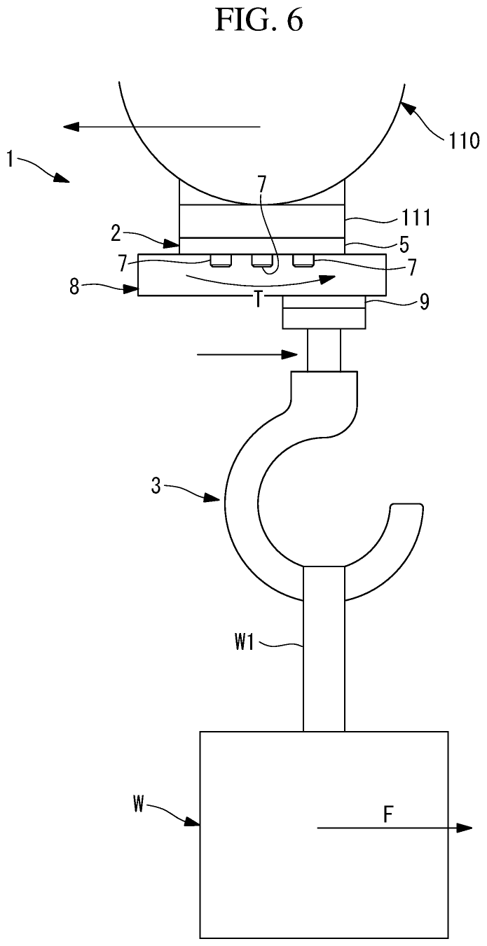

For example, as shown in FIG. 6, the movable connection unit that consists only of the linear movement mechanism 8 in one horizontal direction may be employed. In this case, the base 2 is rotated about a rotation axis of the attachment flange 111 of the robot 100 prior to the transfer of the workpiece W, so that the moving-direction of the linear movement mechanism 8 may coincide with an operation direction of the workpiece W.

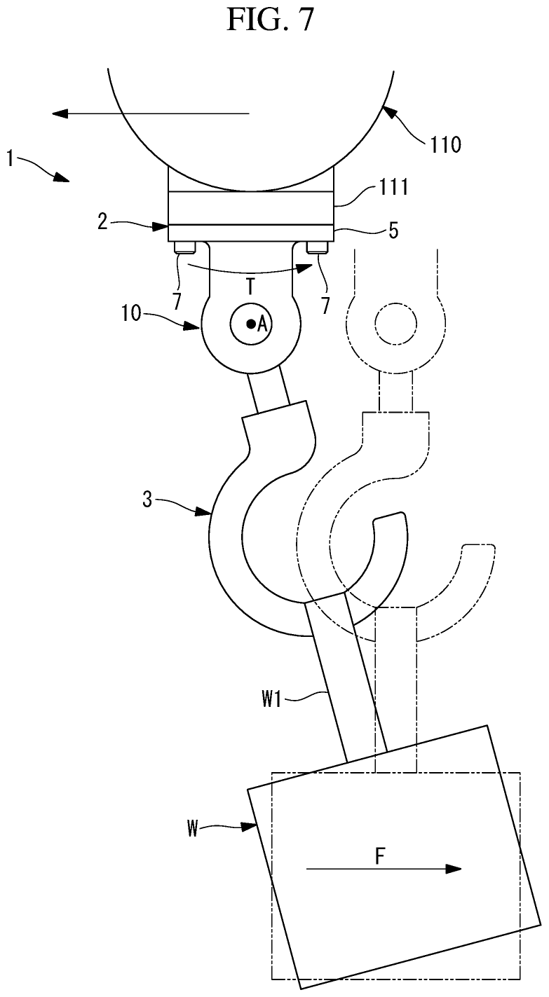

Furthermore, as shown in FIG. 7, a rotation support mechanism 10 that supports the hook 3 swingably about a single horizontal rotation axis (an axis) A may be employed as the movable connection unit. Also, in this case, the base 2 is rotated about the rotation axis of the attachment flange 111 of the robot 100 prior to the transfer of the workpiece W, so that the rotation axis A of the movable connection unit 10 may coincide with a direction orthogonal to the operation direction of the workpiece W.

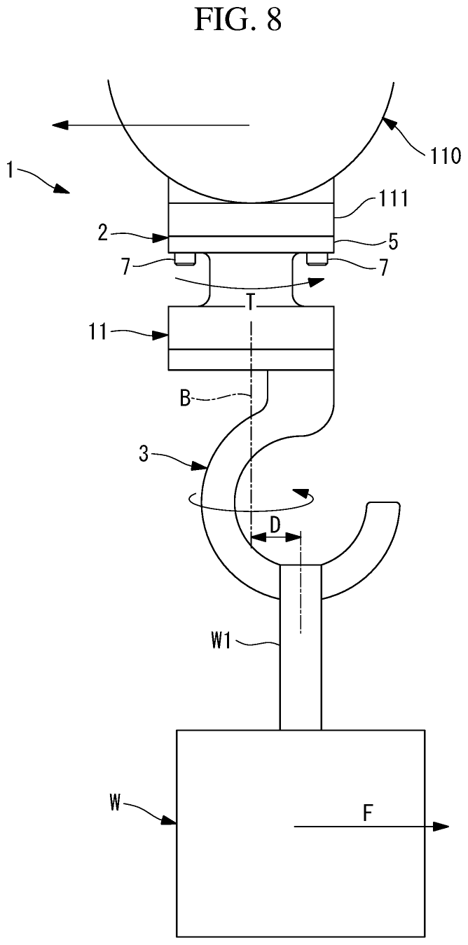

Alternatively, as shown in FIG. 8, a movable connection unit 11 may be a mechanism that supports the hook 3 to the base 2 rotatably about a rotation axis (a vertical axis) B of the attachment flange 111. For example, a bearing is used, so that the hook 3 is easily supported rotatably about the rotation axis B to the base 2.

Here, the hook 3 is designed in a shape such that a gravity position of the workpiece W hung on the hook 3 is disposed at a distance D away from the rotation axis B in the horizontal direction. That is, the hook 3 has an inner surface curved in a U-shape, and the lowest point of curvature of the inner surface of the hook disposed at a hung position is located at a distance away from the rotation axis B in the horizontal direction.

For example, if the handle W1 of the workpiece W is disposed vertically above the gravity of the workpiece W and is hung on the hook 3, the handle W1 of the workpiece W follows the curvature of the inner surface of the hook to move toward the lowest point of the hook 3. As a result, in a state where the workpiece W is hung on the hook 3, the gravity of the workpiece W is disposed away from the rotation axis B in the horizontal direction by the distance D.

Also, in this case, it is preferable to provide an urging means made of an elastic body such as a spring for forcibly disposing the hook 3 at a predetermined positioning position around the rotation axis B to the base 2. This allows the hook 3 to be stationary at a predetermined rotation angle position to the rotation axis B in a state where the robot 100 is stopped.

Then, when transferring the workpiece W, the attachment flange 111 is rotated in a direction in which the lowest point of the hook 3 is offset in a direction orthogonal to a transfer direction, prior to the transfer of the workpiece W. This allows the hook 3 to be rotated about the rotation axis B, and the external force F to be alleviated when the external force F acts on the workpiece W due to the movement of the robot 100.

Furthermore, in the present embodiment, as the workpiece holder releasably holding the workpiece W, the hook 3 on which the workpiece W is hung is illustrated. Alternatively, a hand that grips the workpiece W or a suction device that attracts the workpiece W may be employed as the workpiece holder 3.

1. A workpiece transferring tool comprising:
a base mounted on a distal end of a wrist of a robot,
a workpiece holder releasably holding a workpiece, and
a movable connection unit connecting the workpiece holder to the base so that the workpiece holder is displaceable in an escape direction of an external force acting on the workpiece.

2. The workpiece transferring tool according to claim 1, wherein the movable connection unit is movable at least in a main moving-direction of the workpiece by the robot.

3. The workpiece transferring tool according to claim 2, wherein the movable connection unit is a rotation support mechanism connected in a swingable manner about an axis orthogonal to at least the main moving-direction.

4. The workpiece transferring tool according to claim 3, wherein the rotation support mechanism is a universal joint or a spherical bearing.

5. The workpiece transferring tool according to claim 2, wherein the movable connection unit is a linear movement mechanism making the connection linearly movable in at least the main moving-direction.

6. The workpiece transferring tool according to claim 3, wherein the movable connection unit supports the workpiece holder so that the workpiece support is rotatably supported by the base about a vertical axis, and
the workpiece holder holds the workpiece at a position away from the vertical axis in a horizontal direction.

7. The workpiece transferring tool according to claim 1, further comprising an urging means provided between the base and the workpiece holder to forcibly return the workpiece holder toward a reference position relative to the base.

8. The workpiece transferring tool according to claim 1, wherein the workpiece holder is a hook on which the workpiece is hung.

9. The workpiece transferring tool according to claim 1, wherein the workpiece holder is a hand that grips the workpiece.

10. The workpiece transferring tool according to claim 1, wherein the workpiece holder is a suction device that attracts the workpiece.
